(19) United States
(12) Patent Application Publication
(10) Pub. No.: US 2025/0335332 A1
(43) Pub. Date: Oct. 30, 2025

(54) Identifying Open-Source Software Dependencies in Binary Files

(71) Applicant: Dell Products L.P., Round Rock, TX (US)

(72) Inventors: George Kraft, IV, Wichita Falls, TX (US); Kristopher Gilly, Leander, TX (US); Jeffrey Harnois, Webster, MA (US); Phillip Nordwall, Everett, WA (US)

(73) Assignee: Dell Products L.P., Round Rock, TX (US)

(21) Appl. No.: 18/650,572

(22) Filed: Apr. 30, 2024

(51) Int. Cl. G06F 11/36

(52) U.S. Cl. CPC G06F 11/3608

(57) ABSTRACT

Embodiments are directed to systems and methods for identifying open source software (OSS) required in an application. In one embodiment, a binary file associated with the application is received. The binary file is examined to identify a first library dynamically linked to the application. The first library is examined to identify a second library dynamically linked to the first library, where the second library is not identified in the binary file. The first library is mapped to a first OSS package, and the second library is mapped to a second OSS package. A first OSS license is identified in the first OSS package, and a second OSS license is identified in the second OSS package. Details related to the first OSS license and the second OSS license are extracted from the first and second OSS packages. The details are used to complete an OSS manifest.

### BACKGROUND

Open-source software (OSS) is a type of computer software whose source code is released under a license in which the copyright holder grants others the rights to study, change, and distribute the software to anyone and for any purpose. OSS is typically created through community collaboration and is maintained and updated on a volunteer basis. Anyone can use, modify, and share OSS. There is wide adoption of OSS and even developers at major corporations use OSS to augment proprietary code developed in-house. However, managing OSS in software development can present workflow and other challenges.

OSS presents risks such as licensing limitations as well as security vulnerabilities and targeted attacks. OSS developers have no legal obligation for security or community support, so directions on how to implement OSS securely may be lacking. Often OSS includes or requires the use of third-party libraries that are pulled in from package managers without inspection. This makes it difficult and time-consuming to identify and patch any vulnerabilities that third-party libraries might introduce.

Furthermore, there are more than one hundred variations of OSS licenses that can be applied to OSS components, such as the Apache, MIT (Massachusetts Institute of Technology), GPL (GNU General Public License), AGPL (GNU Affero General Public License), MPL (Mozilla Public License), and BSD (Berkeley Software Distribution) licenses. Open source licenses are licenses that comply with the Open Source Definition, which allows software to be freely used, modified, and shared. To be approved by the Open Source Initiative (OSI), a license must go through the Open Source Initiative's license review process. Many of these licenses are incompatible with each other and, therefore, certain components cannot be used together since the developer cannot comply with all of the terms across multiple licenses. Additionally, some OSS licenses include “copyleft” clauses (i.e., a “reciprocal license”) that require developers to release software created with the covered components as open-source without a fee. A reciprocal license may sometimes be applied to co-mingled code which makes it undesirable for use in commercial purposes.

### SUMMARY

Embodiments are directed to systems and methods for identifying open source software (OSS) required in an application. In one embodiment, a binary file associated with the application is received. The binary file is examined to identify a first library dynamically linked to the application. The first library is examined to identify a second library dynamically linked to the first library, where the second library is not identified in the binary file. The first library is mapped to a first OSS package, and the second library is mapped to a second OSS package. The libraries may be mapped to OSS packages using a library API. A first OSS license is identified in the first OSS package, and a second OSS license is identified in the second OSS package. Details related to the first OSS license and the second OSS license are extracted from the first and second OSS packages. The details are used to complete an OSS manifest. The details may comprise one or more of an OSS library name, an OSS library version, an OSS license identifier, and a source location for the OSS library.

The second library may be examined to identify a third library dynamically linked to the second library, where the third library is not identified in the binary file. The third library is mapped to a third OSS package. A third OSS license is identified in the third OSS package. Transitive and/or recursive dependencies may also be identified among the libraries.

Particular OSS licenses that are reciprocal or that have a restrictive impact on the application may also be identified.

A software bill of materials (SBOM) may be completed at least in part using data collected from the first OSS package and the second OSS package.

A visual map may be generated to show hierarchical, transitive, and recursive relationships may be among the binary file and the first, second, and third libraries.

In some embodiments, the first OSS license and/or the second OSS license comprise sets of two or more OSS licenses (i.e., multiple licenses applying to one OSS package). The binary file may have a Linux Executable and Linkable Format (ELF) file format, and the first and second OSS packages have an RPM package format.

The dependent libraries may be identified using a DT_NEEDED tag in the binary file or in a library package.

The binary file may be a Go programming language buildinfo package. The dependent libraries may be identified using a dep tag in the binary file or in a library package.

The examining, mapping, and identifying steps are performed by a linker or a compiler.

In another embodiment, identifying OSS required in an application includes the steps of receiving a binary file associated with the application, examining the binary file to identify Application Binary Interface (ABI) symbols, comparing the ABI symbols to a list of static libraries to identify static libraries in the application, determining if any static libraries are OSS libraries, and identifying OSS licenses associated with the OSS libraries. Details related to the OSS licenses may be extracted, and an OSS manifest may be completed using the details. The details may include one or more of an OSS library name, an OSS library version, an OSS license identifier, and a source location for the OSS library.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example list of shared libraries required for an executable or shared object file.

FIG. 2 illustrates an example list displaying information about a library package, such as the types of open sources licenses that apply to the library.

FIG. 3 illustrates a series of related libraries in an example application.

FIG. 4 is an example OSS manifest for an application binary listing OSS libraries identified from DT_NEEDED tags across multiple dependencies.

FIG. 5 illustrates an example dependency tree for a project.

FIG. 6 is an example information handling system configured to implement systems and methods for calculating transitive dependencies looking for reciprocal and restricted OSS licenses that would impact a project.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

A programming library is a collection of pre-compiled pieces of code that provide reusable functions, routines, classes, data structures, etc. that can be reused in different programs. Dynamic libraries are a collection of object files that are referenced at build time to give the executable information on how the library will eventually be used; however, dynamic libraries are not used until run time. Static libraries are separate files of executable code that gets embedded into the executable at build time. A static library is like an archive of object files that are compiled from the source code.

The embodiments disclosed herein examine binary applications for dynamic and static linking to libraries. The dependent libraries are mapped to OSS licenses and vulnerabilities. The dependencies are reviewed for reciprocal and restricted OSS licenses that would impact the top-level linking package, which may be unaware of restrictions in dependent OSS libraries. As used herein, a “package” is a logical collection of executables, libraries, configuration files, and documentation.

In Linux and Unix-based systems, the Executable and Linkable Format (ELF) is the standard file format used for storing executable files, binaries, and libraries on disk. The design of the ELF format allows it to be executed on various processor types. Generally, most programs are written in high-level languages that cannot be directly executed on the processor because the processor does not understand program these instructions. Instead, a compiler is used to compile the high-level language into object code. Using a linker, the object code is linked with shared libraries to get a binary file. The resulting binary file has instructions that the processor can understand and execute.

The ELF file comprises an ELF header followed by file data. The file data may include a program header table, a section header table, and data. The section header table is used during link time to create an executable, while the program header table is used during runtime to load the executable into memory.

An application file lists required libraries in DT_NEEDED fields in the dynamic section of the binary. The actual library is held in a file on disk, usually in libraries or at/usr/lib for optional libraries. When the application starts, the dynamic linker looks at the DT_NEEDED fields to find the required libraries. This field contains the names of needed libraries, which the dynamic linker looks for in all the libraries in its search path. The DT_NEEDED entries are read to get dynamic and static library dependencies. The entries may specify that one or more library files as requested or required to successfully compile or execute the corresponding program file.

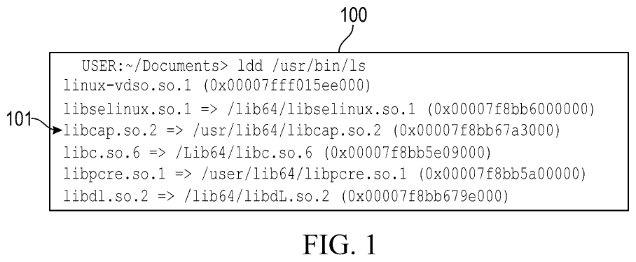

The Idd command (List Dynamic Dependencies) is a Linux/Unix utility that lists the shared libraries that are used by a specified dynamically-linked executable. FIG. 1 is an example list 100 of shared libraries required for an executable or shared object file Is in the directory path usr/bin/. For example, the library libcap 101 implements user-space interface capabilities available in the Linux OS.

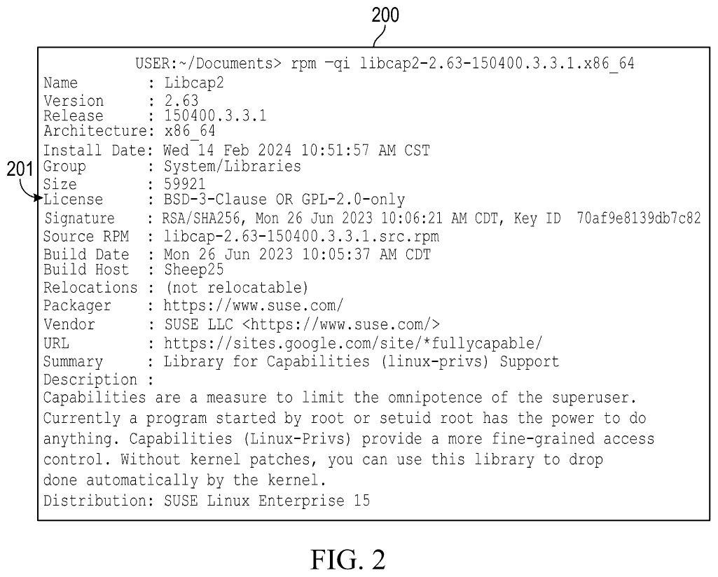

Detailed information for each of the libraries can be viewed using the rpm (Redhat Package Manager) package management tool, for example. The RPM database on Linux is read to map dynamic and/or static libraries to OSS packages. FIG. 2 is an example list 200 displaying information about the libcap 101 library package, such as the types of open sources licenses 201 that apply to the library. In the illustrated example, the libcap library is available under a dual licensing option offering either the BSD 3-clause license, which is a permissive OSS license, or the GPL-2.0-only license, which is a copyleft or reciprocal license OSS license. The rpm tool can also be used to inspect the other libraries in list 100 (FIG. 1) to identify the other licenses that are transitively incorporated into the executable.

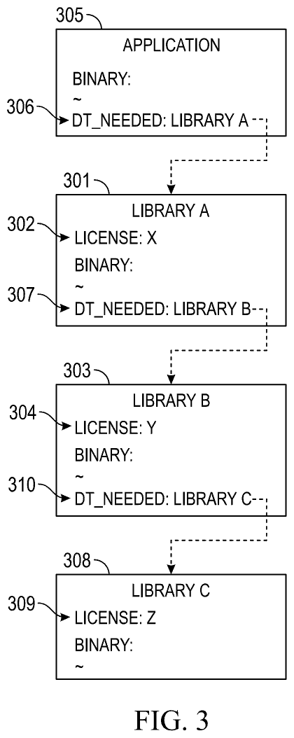

Often an executable will contain many libraries or shared objects that use functionality from each other. FIG. 3 illustrates a series of related libraries in an example application. A first OSS libraryA 301 is available under OSS license X 302. LibraryA 301 uses functionality from a second libraryB 303 to do some of its work. LibraryB 303 is available under OSS license Y 304. An application 305 calls functions in libraryA 301 but not libraryB 303. The developer invoking the linker to link application 305 knows to build with libraryA 301 because the developer know that application 305 uses libraryA 301 So, the developer includes an ELF DT_NEEDED tag 306 in application 305 for libraryA 301. However, because they do not know how the internals of libraryA 301 work, the developer may not know that libraryB 303 should be linked in application 305.

LibraryA 301 handles this by including a DT_NEEDED tag to 307 indicate that it requires libraryB 303. The linker building application 305 only needs DT_NEEDED tag 306 to start. The linker will also read DT_NEEDED tag 307 in libraryA 301 and will link in libraryB 303 automatically. However, while the developer may know that application 305 incorporates OSS license X 302 as part of libraryA 301, they may not realize that OSS license Y 304 from libraryB 303 is also being incorporated.

Additional libraries and OSS licenses may be incorporated into application 305 if, for example, libraryB 303 further uses functionality from a third libraryC 308. LibraryC 308 is available under OSS license Z 309. LibraryB 303 includes a DT_NEEDED tag 310 to indicate that it needs libraryC 308. The linker building application 305 will further read DT_NEEDED tag 310 in libraryB 303 and will automatically link in libraryC 308, thereby also incorporating OSS license Z 309.

In the example illustrated in FIG. 3, the licenses X 302, Y 304, and Z 309 may represent individual OSS license or they may list more than one OSS license for a particular OSS library, such as the dual licenses 201 listed in FIG. 2. In the case where more than one OSS license is listed, users may have a choice-of-license scenario (i.e., an “OR” situation where the user complies with either license) or a multi-license scenario (i.e., an “AND” situation where the user complies with both licenses). The different license types may include, for example, a copyleft or reciprocal license, a permissive OSS license, and/or a commercial license. The more OSS components that are used, the more difficult it is to track and compare all of the OSS license stipulations.

Open-source software is often developed by independent developers, and the development and distribution of OSS is not regulated. This introduces the risk of including insecure code vulnerabilities when using OSS libraries. When OSS libraries include or require the use of other, third-party libraries that are pulled in from package managers without inspection, it is difficult to identify and patch any vulnerabilities in these additional libraries. Moreover, the additional libraries can include unknown OSS licenses that can create intellectual property conflicts.

Using a recursive process, a binary application can be examined using introspection tools for dynamic linking to other libraries. The dependent libraries can then be mapped to OSS packages. The dependent libraries may be identified, for example, using the DT_NEEDED field in an ELF file format. Package level dependency is where OSS licenses would be declared. For the RPM package format, for example, libraries can be mapped to OSS packages using a library API. Transitive or recursive dependencies are identified for additional libraries that are required.

After reading the DT_NEEDED records from a binary application, the library dependencies can be mapped to OSS packages. This information can then be used to complete an OSS manifest, for example.

Static libraries are not identified using the DT_NEEDED records. Instead, when an application links against a static library, the static library's code becomes part of the resulting executable. This is performed only once at linking time. The static libraries usually end with the “.a” extension. A static library is an archive of object files that are usually in the ELF format. Static libraries often include OSS components and are subject to OSS licenses. Some static libraries may be subject to reciprocal licenses which would be undesirable for the same reasons as noted above for dynamic libraries.

The ar command maintains the indexed libraries used by the linkage editor. The ar command can specify any number of optional flags. The -t flag lists all files in the library (ar-t). The archive's files can be extracted with -x flag (ar-x). The extracted files are object files in ELF format. Static libraries that are compiled into an application can be resolved by looking at Application Binary Interface (ABI) symbols in the application. These symbols can then be compared to static libraries on the system to identify which static libraries are included in the application. Those static libraries can then be evaluated for OSS license types.

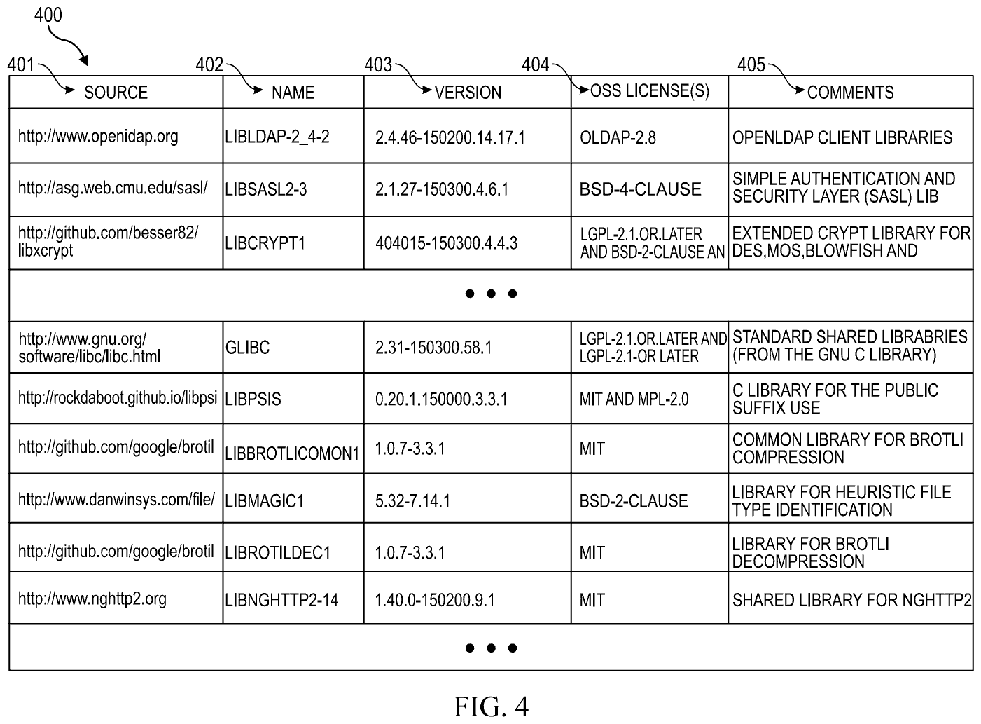

FIG. 4 is an example OSS manifest 400 for an application binary. Dynamic OSS libraries are identified from DT_NEEDED tags across multiple dependencies, and static OSS libraries are identified from ABI symbols. The source URL for each OSS library is listed in column 401, and the OSS library name is listed in column 402. The version of the OSS library is listed in column 403. The OSS version is important since the type of license may vary across versions. Additionally, vulnerabilities may vary across different versions of the same library.

Column 404 lists the OSS license(s) that apply to each library. Comments or other information may be included in column 405. In one embodiment, the OSS manifest 400 is created for each software build to identify dependencies and required OSS licenses. A developer can then evaluate whether there are conflicts with any of the OSS licenses, such as restrictions on commercial use or sale of the build.

The DT_NEEDED tags can be used in Linux binaries to find RPM package dependences that can be used to identify OSS licenses. Each library listed in a DT_NEEDED tag can be further iterated to find other dependencies. In other programming languages, similar dependencies can be found using other techniques. For example, in the Go programming language (“Golang”), the buildinfo package can be used to identify dependencies. The buildinfo package includes information about how a Go binary was built such as the Go toolchain version and the set of modules used. buildinfo also uses the dep tool for managing package dependencies in Go projects. Go also manages dependencies as modules. Similar to the process described for ELF binaries, in a Go binary the dependencies can be iterated to identify OSS libraries and their respective OSS licenses.

In another example, Docker is a platform designed to help developers build, share, and run container applications. A container is an isolated environment for code. Containers have everything that code needs in order to run. Containers create an isolated environment, sometimes referred to as a sandbox, in which applications and their dependencies can live. Accordingly, docker containers can be mined to identify OSS libraries and their respective OSS licenses.

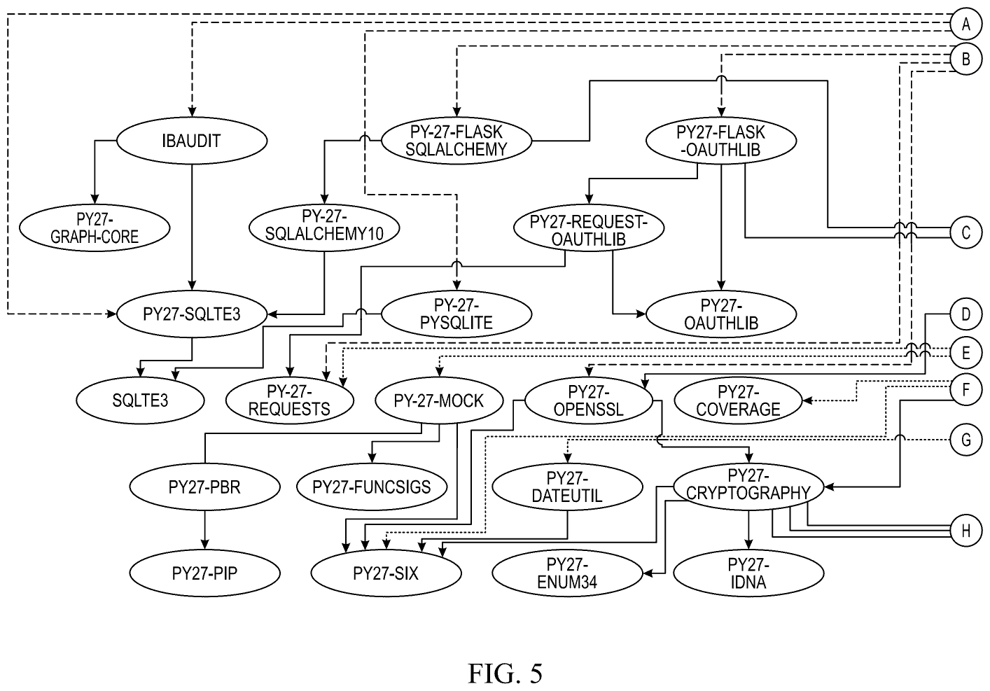

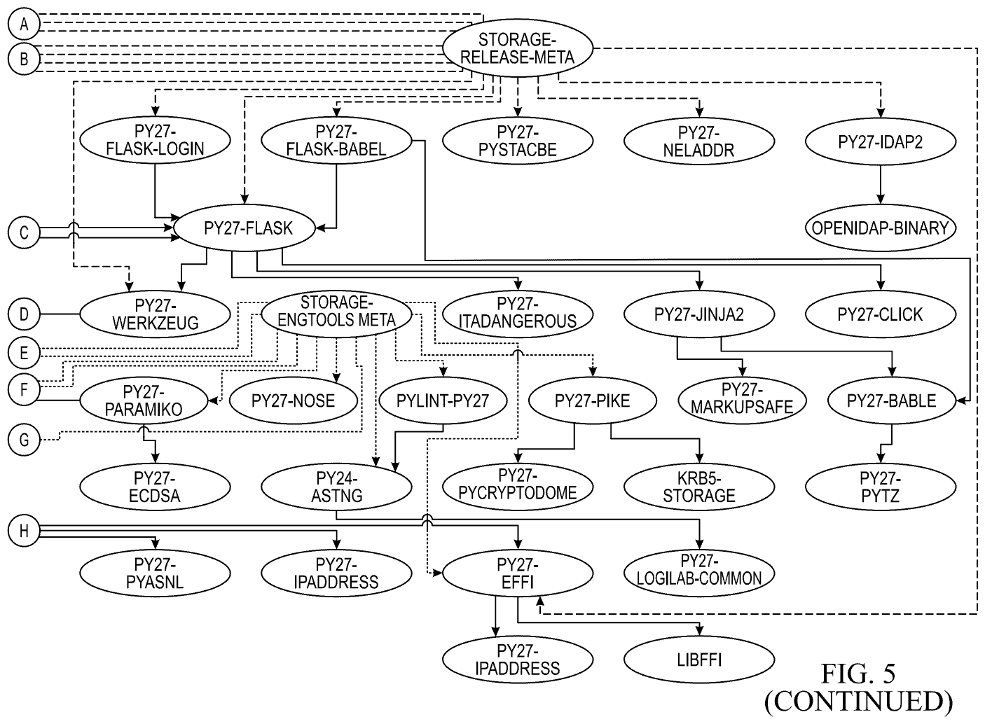

FIG. 5 illustrates an example dependency tree 500 for a project coded in Python. As shown in FIG. 5, different data structures may call on the same dependent data structure or one data structure may have multiple dependencies. By iterating through all of the dependencies, the OSS libraries and their respective OSS licenses can be identified for the project.

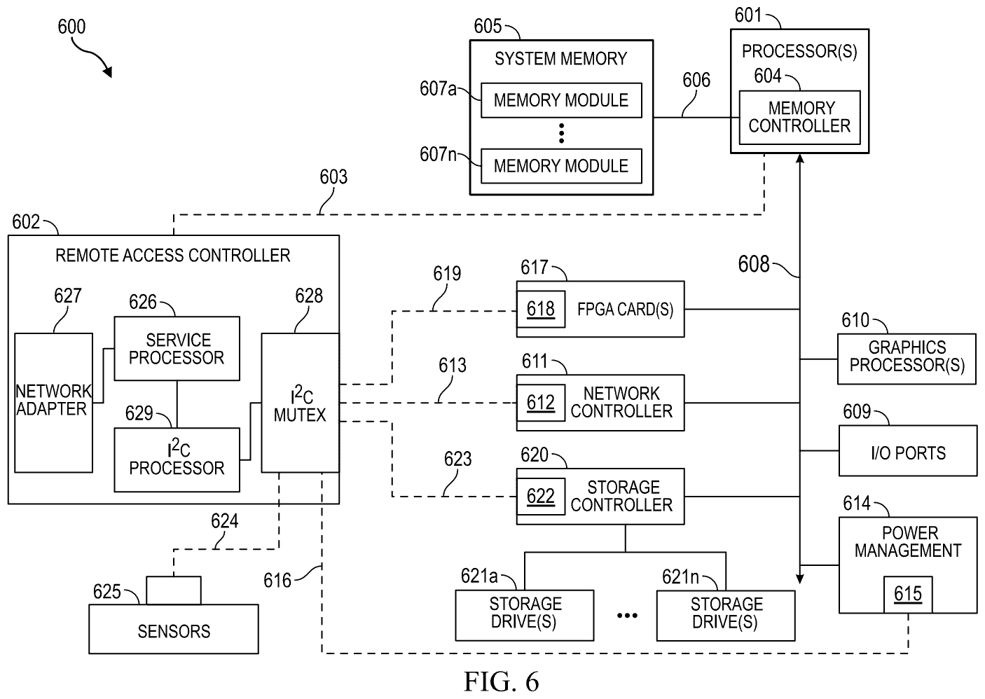

FIG. 6 shows an example of an Information Handling System (IHS) 600 configured to implement systems and methods described herein for calculating transitive (i.e., recursive) dependencies looking for reciprocal and restricted OSS licenses that would impact a project. IHS 600 may also be used for project development, such as compiling or linking functions. It should be appreciated that although the embodiments described herein may describe an IHS that is a compute sled, server, or similar computing component that may be deployed within a rack-mounted chassis, other embodiments may be utilized with other types of IHSs.

IHS 600 may be a compute sled, such as compute that may be installed within a datacenter that may in turn be installed within a rack. Installed in this manner, IHS 600 may utilize shared power, network and cooling resources provided by the datacenter and/or rack. IHS 600 may utilize one or more processors 601. In some embodiments, processors 601 may include a main processor and a co-processor, each of which may include a plurality of processing cores that, in certain scenarios, may be used in operating multiple virtualized computing environments. In certain embodiments, one or all of processor(s) 601 may be graphics processing units (GPUs) in scenarios where IHS 600 has been configured to support functions such as multimedia services and graphics applications.

In some embodiments, processor 601 may be configured to operate as a source of telemetry data providing physical sensor data, such as junction temperatures and power consumption. Processor 601 may also be configured to operate as a source logical telemetry data, such as remaining CPU processing capacity. In some embodiments, processor 601 may be configured by remote access controller 602 to generate telemetry data that is reported to the remote access controller, where the configuration and reporting of this telemetry data may be via a PECI (Platform Environment Control Interface) bus 603.

As illustrated, processor(s) 601 includes an integrated memory controller 604 that may be implemented directly within the circuitry of the processor 601, or the memory controller 604 may be a separate integrated circuit that is located on the same die as the processor 601. The memory controller 604 may be configured to manage the transfer of data to and from the system memory 605 of the IHS 600 via a high-speed memory interface 606. In some embodiments, memory controller 604 may be configured to operate as a source of telemetry data capable of generating reports that are reported to remote access controller 602. The telemetry data reported by memory controller 604 may include metrics such as the amount of available system memory 605 and memory transfer rates via memory interface 606.

The system memory 605 is coupled to processor(s) 601 via a memory bus 606 that provides the processor(s) 601 with high-speed memory used in the execution of computer program instructions by the processor(s) 601. Accordingly, system memory 605 may include memory components, such as static RAM (SRAM), dynamic RAM (DRAM), or NAND Flash memory, suitable for supporting high-speed memory operations by the processor(s) 601. In certain embodiments, system memory 605 may combine both persistent, non-volatile memory and volatile memory. In certain embodiments, the system memory 605 may be comprised of multiple removable memory modules. The system memory 605 of the illustrated embodiment may include removable memory modules 607a-n. Each of the removable memory modules 607a-n may correspond to a printed circuit board memory socket that receives a specific type of removable memory module 607a-n, such as a DIMM (Dual In-line Memory Module), that can be coupled to the socket and then decoupled from the socket as needed, such as to upgrade memory capabilities or to replace faulty components. Other embodiments of IHS system memory 605 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 600 may utilize a chipset that may be implemented by integrated circuits that are connected to each processor 601. All or portions of the chipset may be implemented directly within the integrated circuitry of an individual processor 601. The chipset may provide the processor(s) 601 with access to a variety of resources accessible via one or more buses 608. Various embodiments may utilize any number of buses to provide the illustrated pathways served by bus 608. In certain embodiments, bus 608 may include a PCIe (PCI Express) switch fabric that is accessed via a PCIe root complex. IHS 600 may also include one or more I/O ports 609, such as PCIe ports, that may be used to couple the IHS 600 directly to other IHSs, storage resources or other peripheral components.

In certain embodiments, a graphics processor 610 may be comprised within one or more video or graphics cards, or an embedded controller, installed as components of the IHS 600. In certain embodiments, graphics processor 610 may be an integrated of the remote access controller 602 and may be utilized to support the display of diagnostic and administrative interfaces related to IHS 600 via display devices that are coupled, either directly or remotely, to remote access controller 602.

In the illustrated embodiments, processor(s) 601 is coupled to a network controller 611, such as provided by a Network Interface Controller (NIC) that is coupled to the IHS 600 and allows the IHS 600 to communicate via an external network, such as the Internet or a LAN. As illustrated, network controller 611 may be instrumented with a controller or other logic unit 612 that supports a sideband management connection 613 with remote access controller 602. Via the sideband management connection 613, network controller 611 may be configured to operate as a source of telemetry data that may include environmental metrics, such as temperature measurements, and logical sensors, such as metrics reporting input and output data transfer rates.

Processor(s) 601 may also be coupled to a power management unit 614 that may interface with the power system unit of a datacenter in which IHS 600 may be installed. As with network controller 611, power management unit 614 may be instrumented with a controller or other logic unit 615 that supports a sideband management connection 616 with remote access controller 602. Via the sideband management connection 616, power management unit 614 may be configured to operate as a source of telemetry data that may include physical sensors, such as a sensors providing temperature measurements and sensors providing power output measurements, and logical sensors, such as capabilities reporting discrete power settings.

As illustrated, IHS 600 may include one or more FPGA (Field-Programmable Gate Array) card(s) 617. Each FPGA card 617 supported by IHS 600 may include various processing and memory resources, in addition to an FPGA integrated circuit that may be reconfigured after deployment of IHS 600 through programming functions supported by the FPGA card 617. FGPA card 617 may be optimized to perform specific processing tasks, such as specific signal processing, security, data mining, and artificial intelligence functions, and/or to support specific hardware coupled to IHS 600. FPGA card 617 may include one or more physical and/or logical sensors. As specialized computing components, FPGA cards may be used to support large-scale computational tasks that may result in the FPGA card 617 generating significant amounts of heat. In order to protect specialized FPGA cards from damaging levels of heat, FPGA card 617 may be outfitted with multiple temperature sensors. FPGA card 617 may also include logical sensors that are sources of metric data, such as metrics reporting numbers of calculations performed by the programmed circuitry of the FPGA. The FPGA card 617 may also include a management controller 618 that may support interoperation was the remote access controller 602 via a sideband device management bus 619.

In certain embodiments, IHS 600 may operate using a BIOS (Basic Input/Output System) that may be stored in a non-volatile memory accessible by the processor(s) 601. The BIOS may provide an abstraction layer by which the operating system of the IHS 600 interfaces with the hardware components of the IHS. Upon powering or restarting IHS 600, processor(s) 601 may utilize BIOS instructions to initialize and test hardware components coupled to the IHS, including both components permanently installed as components of the motherboard of IHS 600, and removable components installed within various expansion slots supported by the IHS 600. The BIOS instructions may also load an operating system for use by the IHS 600. In certain embodiments, IHS 600 may utilize Unified Extensible Firmware Interface (UEFI) in addition to or instead of a BIOS. In certain embodiments, the functions provided by BIOS may be implemented, in full or in part, by the remote access controller 602.

IHS 600 may include one or more storage controllers 620 that may be utilized to access storage drives 621a-n that are accessible via the chassis in which IHS 600 is installed. Storage controller 620 may provide support for RAID (Redundant Array of Independent Disks) configurations of logical and physical storage drives 612a-n. In some embodiments, storage controller 620 may be an HBA (Host Bus Adapter) that provides more limited capabilities in accessing physical storage drives 621a-n. In some embodiments, storage drives 621a-n may be replaceable, hot-swappable storage devices that are installed within bays provided by the chassis in which IHS 600 is installed. In some embodiments, storage drives 621a-n may also be accessed by other IHSs that are also installed within the same chassis as IHS 600.

In embodiments where storage drives 621a-n are hot-swappable devices that are received by bays of datacenter, the storage drives 621a-n may be coupled to IHS 600 via couplings between the bays of the chassis and a midplane of IHS 600. Storage drives 621a-n may include SAS (Serial Attached SCSI) magnetic disk drives, SATA (Serial Advanced Technology Attachment) magnetic disk drives, solid-state drives (SSDs) and other types of storage drives in various combinations.

In some embodiment, IHS 600 may be used to implement file sharing systems that utilize the Server Message Block (SMB) file sharing protocol. The Server Message Block protocol is a client-server communication protocol used for sharing access to files, and in some cases other resources, over a network. In a file sharing, the SMB protocol provides the inter-process communications that implement protocols for file-level transactions. The SMB protocol is a network file sharing protocol that allows client applications on a user's IHS to setup and conduct remote file level operations, such as reading and writing shared files. In some embodiments, an SMB file sharing system may be implemented using an IHS 600 in which one or more storage drives 621a-n are utilized as shared volumes that are used to implement a file system that is shared through use of SMB commands by users of the file sharing system. In some embodiments, the shared volumes of an SMB file sharing system may utilize storage drives on multiple IHSs, such as storage drives 621a-n of multiple IHSs that are similarly configured to IHS 600.

As illustrated, storage controller 620 may be instrumented with a controller or other logic unit 622 that supports a sideband management connection 623 with remote access controller 602. Via the sideband management connection 623, storage controller 620 may be configured to operate as a source of telemetry data regarding the operation of storage drives 621a-n. For instance, controller 622 may collect metric data characterizing the performance of individual storage drives 621a-n, such as available storage capacity and data transfer rates, as well as environmental properties, such as storage drive temperatures. In some embodiments, a storage controller 620 may be utilized in implementing an fille sharing system that utilizes one of more of storge drives 621a-n as shared volumes. In such embodiments, storage controller 620 may monitor SMB commands received from users of the file sharing system. As described below, this collected SMB data may be used to compile a profile of normal file sharing activity by individual users, which may then be used to detect anomalous file sharing activity by that user that is consistent with a ransomware attack. In some embodiments, storage controller 620 may track and maintain a record of recent SMB commands issued by a user of IHS 600, in some instances tracking all SMB commands by a user during an ongoing SMB session. In such embodiments, the session data monitored and collected by storage controller 620 may be used to reverse all SMB commands by a user during and SMB session, such as in response to detecting a ransomware pattern in the SMB commands issued by the user.

In certain embodiments, remote access controller 602 may operate from a different power plane from the processors 601 and other components of IHS 600, thus allowing the remote access controller 602 to operate, and management tasks to proceed, while the processing cores of IHS 600 are powered off. As described, various functions provided by the BIOS, including launching the operating system of the IHS 600, may be implemented by the remote access controller 602. In some embodiments, the remote access controller 602 may perform various functions to verify the integrity of the IHS 600 and its hardware components prior to initialization of the IHS 600 (i.e., in a bare-metal state).

In some embodiments, remote access controller 602 may also be directly coupled via I2C couplings 624 with one or more sensors 625, such as sensors that provide measurements of ambient inlet temperatures, outlet airflow temperatures and temperatures at various locations within IHS 600. Sensors 625 coupled directly to remote access controller 602 may also be used in implementing security protocols, such as intrusion detection sensors and user proximity sensors.

Remote access controller 602 may include a service processor 626, or a specialized microcontroller, that operates management software that supports remote monitoring and administration of IHS 600. Remote access controller 602 may be installed on the motherboard of IHS 600 or may be coupled to IHS 600 via an expansion slot provided by the motherboard. In support of remote monitoring functions, network adapter 627 may support connections with remote access controller 602 using wired and/or wireless network connections via a variety of network technologies. As a non-limiting example of a remote access controller, the integrated Dell Remote Access Controller (iDRAC) from Dell® is embedded within Dell PowerEdge™ servers and provides functionality that helps information technology (IT) administrators deploy, update, monitor, and maintain servers remotely.

In some embodiments, remote access controller 602 may support monitoring and administration of various managed devices 611, 614, 617, 620, 625 of an IHS via a sideband bus interface. For instance, messages utilized in device management may be transmitted using I2C sideband bus connections that may be individually established with each of the respective managed devices 611, 614, 617, 620, 625 through the operation of an I2C multiplexer 628 of the remote access controller. As illustrated, certain of the managed devices of IHS 600, such as FPGA cards 617, network controller 611, storage controller 620 and power management unit 614, are coupled to the IHS processor(s) 601 via an in-line bus 608, such as a PCIe root complex, that is separate from the I2C sideband bus connections 613, 616, 619, 623, 624 used for device management.

In certain embodiments, the service processor 626 of remote access controller 602 may rely on an I2C co-processor 629 to implement sideband I2C communications between the remote access controller 602 and managed components 611, 614, 617, 620, 625 of the IHS. The I2C co-processor 629 may be a specialized co-processor or micro-controller that is configured to interface via a sideband I2C bus interface with the managed hardware 611, 614, 617, 620, 625 of IHS. In some embodiments, the I2C co-processor 629 may be an integrated component of the service processor 626, such as a peripheral system-on-chip feature that may be provided by the service processor 626. Each I2C bus is illustrated as single line in FIG. 6. However, each I2C bus 613, 616, 619, 623, 624 may be comprised of a clock line and data line that couple the remote access controller 602 to I2C endpoints 612, 615, 618, 622 on each of the managed components.

In various embodiments, an IHS 600 does not include each of the components shown in FIG. 6. In various embodiments, an IHS 600 may include various additional components in addition to those that are shown in FIG. 6. Furthermore, some components that are represented as separate components in FIG. 6 may in certain embodiments instead be integrated with other components. For example, in certain embodiments, all or a portion of the functionality provided by the illustrated components may instead be provided by components integrated into the one or more processors 601 as a systems-on-a-chip.

In an example embodiment, a method of identifying open source software (OSS) required in an application includes receiving a binary file associated with the application, examining the binary file to identify a first library dynamically linked to the application, examining the first library to identify a second library dynamically linked to the first library, where the second library is not identified in the binary file, mapping the first library to a first OSS package, mapping the second library to a second OSS package, identifying a first OSS license in the first OSS package, and identifying a second OSS license in the second OSS package.

The method may further include extracting details related to the first OSS license and the second OSS license from the first and second OSS packages and completing an OSS manifest using the details. The details may comprise one or more of an OSS library name, an OSS library version, an OSS license identifier, and a source location for the OSS library. The first OSS license or the second OSS license or both are sets of two or more OSS licenses (i.e., the first and/or second OSS license is a multi-license scenario requiring compliance with two or more licenses).

The binary file may have a Linux Executable and Linkable Format (ELF) file format, and the first and second OSS packages have an RPM package format. The dependent libraries may be identified using a DT_NEEDED tag in the binary file or in a library package.

The binary file may be a Go programming language buildinfo package. The dependent libraries may be identified using a dep tag in the binary file or in a library package.

The method may further include mapping the libraries to OSS packages using a library API.

The method may further include examining the second library to identify a third library dynamically linked to the second library, where the third library is not identified in the binary file, mapping the third library to a third OSS package, and identifying a third OSS license in the third OSS package. The method may further include identifying transitive and/or recursive dependencies among the libraries.

The examining, mapping, and identifying steps may be performed by a linker or a complier or a component designed to create an executable file.

The method may further include identifying OSS licenses that are reciprocal or that have a restrictive impact on the application.

The method may further include completing a software bill of materials (SBOM) at least in part using data collected from the first OSS package and the second OSS package.

The method may further include generating a visual map showing hierarchical, transitive, and recursive relationships among the binary file and the first, second, and third libraries.

In another example embodiment, a method of identifying open source software (OSS) required in an application includes receiving a binary file associated with the application, examining the binary file to identify Application Binary Interface (ABI) symbols, comparing the ABI symbols to a list of static libraries to identify static libraries in the application, determining if any static libraries are OSS libraries, and identifying OSS licenses associated with the OSS libraries. The method may further include extracting details related to the OSS licenses, and completing an OSS manifest using the details. The details may comprise one or more of: an OSS library name, an OSS library version, an OSS license identifier, and a source location for the OSS library.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method of identifying open source software (OSS) required in an application, comprising:
receiving a binary file associated with the application;
examining the binary file to identify a first library dynamically linked to the application;
examining the first library to identify a second library dynamically linked to the first library, where the second library is not identified in the binary file;
mapping the first library to a first OSS package;
mapping the second library to a second OSS package;
identifying a first OSS license in the first OSS package; and
identifying a second OSS license in the second OSS package.

2. The method of claim 1, further comprising:
extracting details related to the first OSS license and the second OSS license from the first and second OSS packages; and
completing an OSS manifest using the details.

3. The method of claim 2, wherein the details comprise one or more of:
an OSS library name;
an OSS library version;
an OSS license identifier; and
a source location for the OSS library.

4. The method of claim 1, wherein the first OSS license or the second OSS license or both are sets of two or more OSS licenses.

5. The method of claim 1, wherein the binary file has a Linux Executable and Linkable Format (ELF) file format, and the first and second OSS packages have an RPM package format.

6. The method of claim 5, wherein dependent libraries are identified using a DT_NEEDED tag in the binary file or in a library package.

7. The method of claim 1, wherein the binary file is a Go programming language buildinfo package.

8. The method of claim 7, wherein dependent libraries are identified using a dep tag in the binary file or in a library package.

9. The method of claim 1, further comprising:
mapping the libraries to OSS packages using a library API.

10. The method of claim 1, further comprising:
examining the second library to identify a third library dynamically linked to the second library, where the third library is not identified in the binary file;
mapping the third library to a third OSS package; and
identifying a third OSS license in the third OSS package.

11. The method of claim 10, further comprising:
identifying transitive and/or recursive dependencies among the libraries.

12. The method of claim 1, wherein the examining, mapping, and identifying steps are performed by a linker.

13. The method of claim 1, wherein the examining, mapping, and identifying steps are performed by a compiler.

14. The method of claim 1, further comprising:
identifying OSS licenses that are reciprocal or that have a restrictive impact on the application.

15. The method of claim 1, further comprising:
completing a software bill of materials (SBOM) at least in part using data collected from the first OSS package and the second OSS package.

16. The method of claim 10, further comprising:
generating a visual map showing hierarchical, transitive, and recursive relationships among the binary file and the first, second, and third libraries.

17. A method of identifying open source software (OSS) required in an application, comprising:
receiving a binary file associated with the application;
examining the binary file to identify Application Binary Interface (ABI) symbols;
comparing the ABI symbols to a list of static libraries to identify static libraries in the application;
determining if any static libraries are OSS libraries; and
identifying OSS licenses associated with the OSS libraries.

18. The method of claim 17, further comprising:
extracting details related to the OSS licenses; and
completing an OSS manifest using the details.

19. The method of claim 18, wherein the details comprise one or more of:
an OSS library name;
an OSS library version;
an OSS license identifier; and
a source location for the OSS library.
